(19) United States
(12) Patent Application Publication
(10) Pub. No.: US 2015/0009159 A1
(43) Pub. Date: Jan. 8, 2015

(54) PORTABLE ELECTRONIC DEVICE

(71) Applicants: SHENZHEN FUTAIHONG PRECISION INDUSTRY CO., LTD., Shenzhen (CN); FIH (HONG KONG) LIMITED, Kowloon (HK)

(72) Inventors: JUN-HUI SHAN, Shenzhen (CN); PING-SHENG LIN, New Taipei (TW)

(21) Appl. No.: 14/322,208

(22) Filed: Jul. 2, 2014

(30) Foreign Application Priority Data
Jul. 5, 2013 (CN) 2013102812470

(51) Int. Cl. G06F 1/16; G06F 3/041

(52) U.S. Cl. CPC G06F 1/1643; G06F 3/0416
USPC 345/173

(57) ABSTRACT

A portable electronic device includes a housing, a touch panel, and a circuit board accommodated in the housing of the device. The housing includes a frame, a connecting member, and a base. The touch panel is accommodated in the frame. The connecting member is made of elastic materials. The circuit board includes a plurality of sensors resisting against the frame. When the touch panel is pressed, the touch panel drives the frame and the connecting member to move forcibly towards the sensors and squeeze the sensors by force, and the sensors output different electrical signals to the circuit board according to the force.

### FIELD

The disclosure generally relates to portable electronic devices, and particularly to portable electronic devices providing tactile experience.

### BACKGROUND

Many electronic devices, such as mobile phones, employ a touch panel for playing games and other operations. For example, in racing games, a user needs to execute an acceleration operation and a deceleration operation on the touch panel by pressing a virtual deceleration button displayed on the touch panel.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the disclosure.

FIG. 1 is an exploded view of a portable electronic device.

FIG. 2 is an exploded view of a first housing of the portable electronic device shown in FIG. 1.

FIG. 3 is an assembled view of the portable electronic device shown in FIG. 1.

FIG. 4 shows a partial cross-sectional view of line IV-IV of the portable electronic device shown in FIG. 3.

FIG. 5 is a view of the portable electronic device shown in FIG. 4 in a working state.

### DETAILED DESCRIPTION

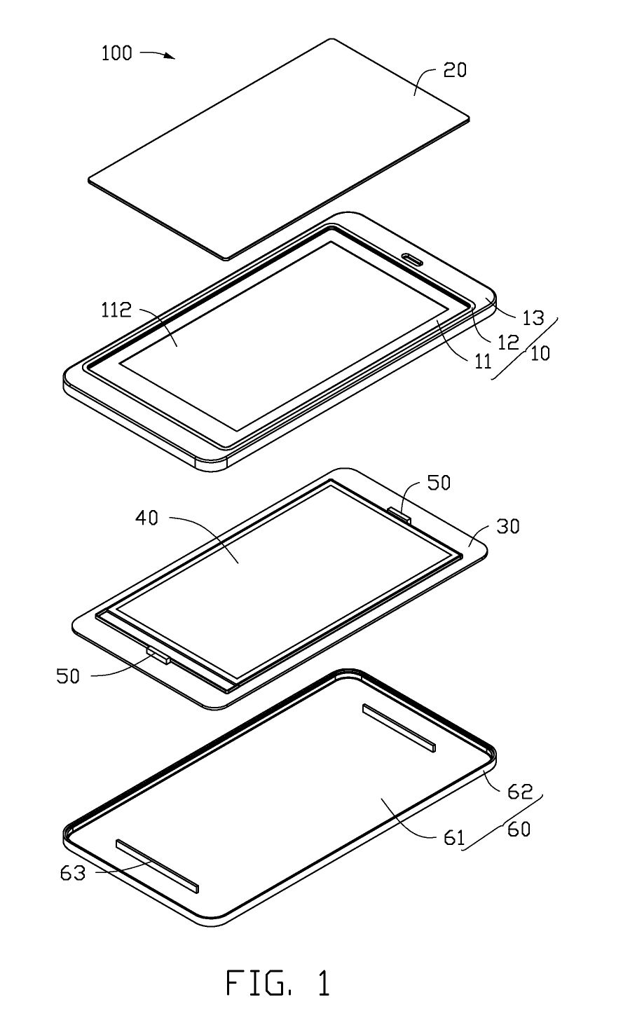

FIG. 1 is an exploded view of a portable electronic device 100, which can be a mobile phone, a personal digital assistant, or other like devices.

The portable electronic device 100 includes a first housing 10, a touch panel 20, a circuit board 30, a liquid crystal display (LCD) module 40, sensors 50, and a second housing 60. The touch panel 20 is fixed to the first housing 10. The LCD module 40 and the sensors 50 are set on the circuit board 30 and abut the touch panel 20. The second housing 60 is used to accommodate the circuit board 30 and is latched to the first housing 10.

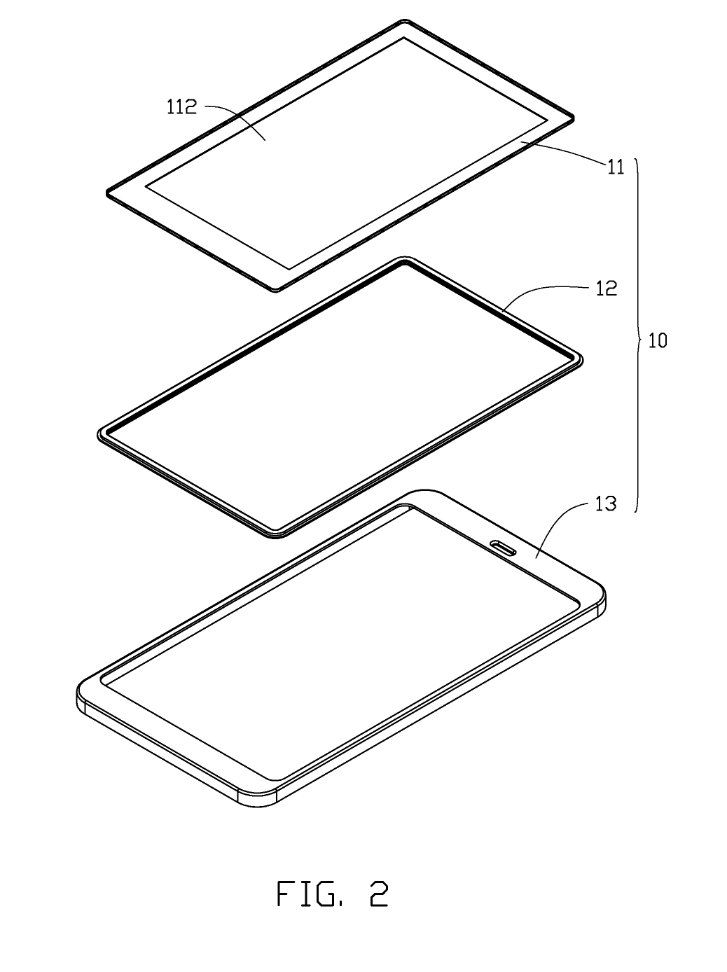

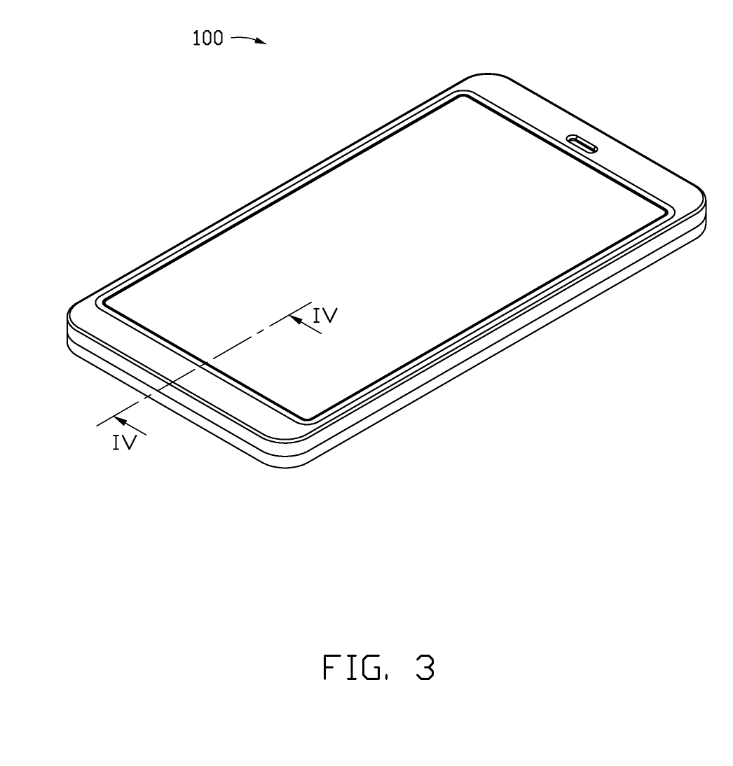

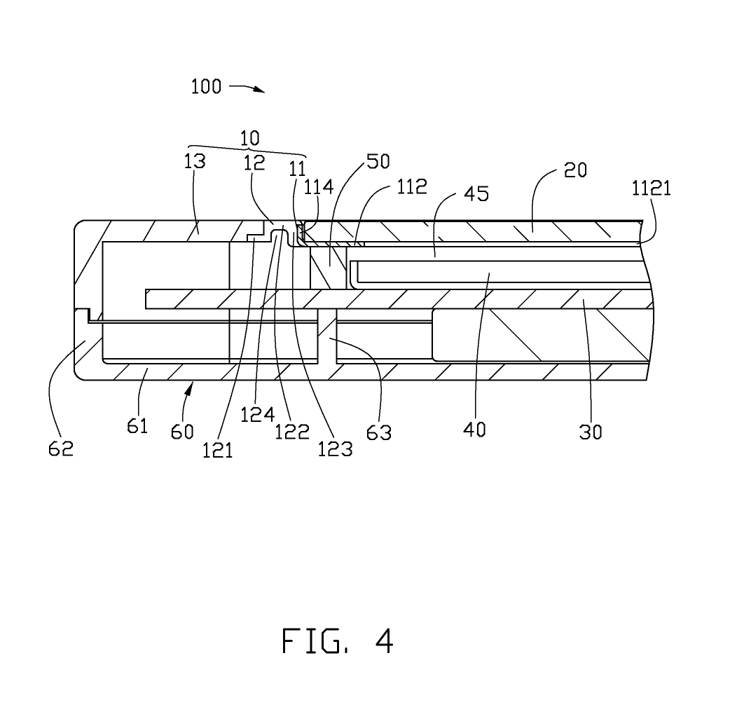

Referring to FIG. 2, the first housing 10 includes a frame 11, a connecting member 12, and a base 13 formed on the frame 11 and the connecting member 12. Referring to FIG. 3, the base 13 is integrally formed with the frame 11 and the connecting member 12. Referring to FIG. 4, the frame 11 is substantially a grooved structure, including a bottom wall 112 and a plurality of side walls 114 around the bottom wall 112. The bottom wall 112 carries the touch panel 20 and defines a hole 1121 to expose the LCD module 40. The frame 11 is made of stainless steel or like material.

The connecting member 12 surrounds the frame 11 to connect the frame 11 to the base 13. The connecting member 12 is made of elastic materials to allow the fame 11 and the connecting member 12 to move a certain distance relative to the base 13. In one exemplary embodiment, the connecting member 12 is made of an elastic thermoplastic polyurethane. The base 13 is made of hard plastic materials to protect an internal structure of the portal electronic device 100.

Referring to FIG. 4, the connecting member 12 is a substantially hollow structure, and includes a first combining portion 121, a connecting portion 122, and a second combining portion 123 connected in turn. An upper surface of the connecting portion 122 is substantially horizontal. The first combining portion 121 is located outside the connecting portion 122, and extends from a bottom of the connecting portion 122 to an inner side of the base 13 to connect to the base 13. The second combining portion 123 is located inside the connecting portion 122, and extends from one side of the connecting portion 122 and connects to the side walls 114 of the frame 11. The bottom of the connecting member 122, the first combining member 121, and the second combining member 122 cooperatively form a groove 124 to facilitate an elastic deformation of the connection member 122.

The base 13 and the touch panel 20 are located at opposite sides of the connecting member 122. The base 13, the connecting member 122, and an upper surface of the touch panel 20 are substantially positioned on a same plane. When the touch panel 20 is compressed such as by a touch, the frame 11 and the combining member 12 are driven to move towards the circuit board 30, and the second combining portion 123 moves simultaneously. At the same time, the connecting portion 122 is deformed, thus an inner side of the connecting portion 122 is moved downward and squeezes the groove 124.

In other exemplary embodiments, the frame 11, the connecting member 12, and the base 13 can also be connected in other ways. For example, opposite sides of the first combining portion 121 and of the second combining portion 122 can be glued. Then the inner side of the base 13 and the side walls 114 of the frame 11 can be glued to the first combining portion 121 and the second combining portion 123 to connect the connecting member 12 to the frame 11 and the base 13 together.

The touch panel 20 can be touched by users to achieve various functions of the portable electronic device 100. In assembly, the touch panel 20 is fixed to the frame 11 of the first housing 10. The touch panel 20 can be pressed to drive the frame 11 and the connecting member 12 to move towards the LCD module 40.

The circuit board 30 is located below the first housing 10 with electronic components such as processors and antennas. In one exemplary embodiment, the LCD module 40 is spaced from the touch panel 20, located below the hole 1121, and electronically connected to the circuit board 30.

In one exemplary embodiment, the number of the sensors 50 is two, and the two sensors 50 are set at opposite sides of the LCD module 40 and electronically connected to the circuit board 30. The two sensors 50 are both pressure sensors. When an external force is applied to the sensors 50, the sensors 50 are deformed, thereby outputting an electrical signal to the circuit board 30. Then the circuit board 30 transmits the signal to the portable electronic device 100. Referring to FIG. 4, heights of the two sensors 50 are greater than a height of the LCD module 40. In assembly, the LCD module 40 fills the hole 1121 of the frame 11, and the two sensors 50 can resist against the bottom wall 112 of the frame 11. Meanwhile, the touch panel 20 keeps a space 45 from the LCD module 40 for allowing the touch panel 20, the frame 11, and the connecting member 12 to move a certain distance towards the LCD module 40.

The second housing 60 includes a body 61 and a plurality of peripheral walls 62 vertically connected to the body 61. The body 61 forms two protrusions 63. The two protrusions 63 are spaced from each other and substantially coplanar with the peripheral walls 62. In assembly, the peripheral walls 62 are latched with the base 13 of the first housing 10, and the two protrusions resist against the circuit board 30 to fix the circuit board 30 between the first housing 10 and the second housing 60.

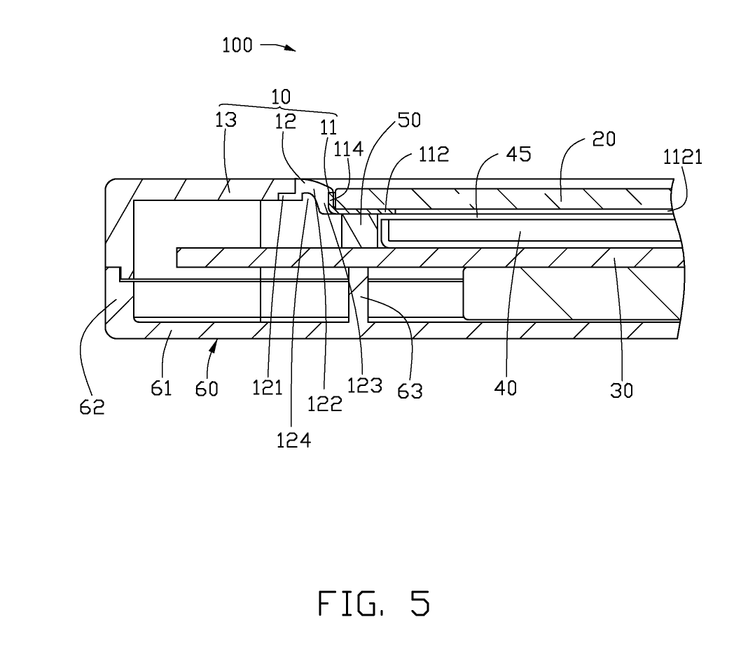

Referring to FIG. 5, when the touch panel 20 is pressed to drive the frame 11 and the connecting member 12 to move towards the circuit board 30, the connecting member 12 is deformed. The frame 11 then squeezes down on the two sensors 50 to drive the two sensors 50 to deform towards the circuit board 30. The two sensors 50 output electrical signals to the processor of the portable electronic device 100 such that the processor executes various functions according to the electrical signals, such as an acceleration operation and a deceleration operation in racing games. When the pressure on the touch panel 20 is taken away, the two sensors 50 rebound against the circuit board 30 to provide an elastic force to drive the touch panel 20 to move upwards, thus driving the frame 11 and the connecting member 12 to move up to the same plane.

In one exemplary embodiment, a movement range of the touch panel 20 is substantially equal to the height of the space 45.

In summary, the frame 11 and the connecting member 12 are located on the first housing 10. The touch panel 20 is accommodated in the frame 11. The LCD module 30 and the sensors are set on the circuit board 40. Functions can be achieved though pressing the touch panel 20 and such pressings provide tactile feedback.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A portable electronic device comprising:
a touch panel;
a first housing comprising:
a frame configured to have the touch panel mounted therein,
a connecting member being made of one or more elastic materials and configured to connect to the frame, and
a base configured to connect to the connecting member; and
a circuit board electronically connected to the touch panel; and
a sensor being configured to output electrical signals to the circuit board in response to the sensor being deformed based upon a motion of the touch panel and the coupled frame and connecting member towards the sensor.

2. The portable electronic device of claim 1, wherein the base and the touch panel are located at opposite sides of the connecting member; and the base, the connecting member, and an upper surface of the touch panel are positioned on a same plane.

3. The portable electronic device of claim 2, wherein the connecting member comprises a first combining portion, a connecting portion, and a second combining portion connected in turn, the bottom of the connecting portion; the first combining portion and the second combining portion cooperatively form a groove; the first combining portion is connected to the base, and the second combining portion is connected to the frame; and the upper surface of the connecting portion, the base and the upper surface of the touch panel are positioned on a same plane.

4. The portable electronic device of claim 2, wherein the first combining portion is located outside the connecting portion and extends from a bottom of the connecting portion to an inner side of the base to connect to the base; the second combining portion is located inside the connecting portion, extends from one side of the connecting portion, and connects to the side walls of the frame.

5. The portable electronic device of claim 1, wherein the frame, the connecting member, and the base are connected in turn and integrally formed.

6. The portable electronic device of claim 3, wherein opposite sides of the first combining portion and the second combining portion are glued, the base is glued to the first combining portion, and the sidewalls of the frame are glued to the second combining portion.

7. The portable electronic device of claim 1, wherein the frame is made of stainless steel materials, the connecting member is made of an elastic thermoplastic polyurethane, and the base is made of hard plastic materials.

8. The portable electronic device of claim 1, further comprising a LCD module spaced form the touch panel, wherein the frame comprises a bottom wall that defines a hole, the LCD module is set on the circuit board and aimed at the hole.

9. The portable electronic device of claim 8, wherein the number of the sensors is two, the sensors are pressure sensors, and the two sensors are set at opposite sides of the LCD module and resist the bottom wall of the frame.

10. The portable electronic device of the claim 1, wherein the second housing forms two protrusions spaced from each other, and the two protrusions are resisted by the circuit board.

11. A portable electronic device comprising:
a touch panel;
a first housing comprising:
a frame configured to have the touch panel mounted therein,
a connecting member being made of one or more elastic materials and configured to connect to the frame, and
a base configured to connect to the connecting member; and
a sensor being configured to output electrical signals in response to the sensor being deformed based upon a motion of the touch panel and the coupled frame and connecting member towards the sensor.

12. The portable electronic device of claim 11, wherein the base and the touch panel are located at two opposite sides of the connecting member; the base, the connecting member, and an upper surface of the touch panel are substantially positioned on a same plane.

13. The portable electronic device of claim 12, wherein the connecting member comprises a first combining portion, a connecting portion, and a second combining portion connected in turn; the bottom of the connecting portion, the first combining portion and the second combining portion cooperatively form a groove; the first combining portion is connected to the base, and the second combining portion is connected to the frame; and the upper surface of the connecting portion, the base, and the upper surface of the touch panel are positioned on a same plane.

14. The portable electronic device of claim 12, wherein the first combining portion is located outside the connecting portion, and extends from a bottom of the connecting portion to an inner side of the base to connect to the base; and the second combining portion is located inside the connecting portion, and extends from one side of the connecting portion and connects to the side walls of the frame.

15. The portable electronic device of claim 11, wherein the frame, the connecting member, and the base are connected in turn and integrally formed.

16. The portable electronic device of claim 13, wherein opposite sides of the first combining portion and the second combining portion are glued, the base is glued to the first combining portion, and the sidewalls of the frame are glued to the second combining portion.

17. The portable electronic device of claim 11, further comprising a LCD module spaced form the touch panel, wherein the frame comprises a bottom wall that defines a hole, the LCD module is set on the circuit board and aimed at the hole.

18. The portable electronic device of claim 17, wherein the number of the sensors is two, the sensors are pressure sensors, the two sensors are set at opposite sides of the LCD module and resist the bottom wall of the frame.
